(19) United States
(12) Patent Application Publication
(10) Pub. No.: US 2011/0196762 A1
(43) Pub. Date: Aug. 11, 2011

(54) ONLINE USER DIRECTED VALUATION MODEL (UDVM)

(76) Inventor: David W. DuPONT, Mill Valley, CA (US)

(21) Appl. No.: 13/021,488

(22) Filed: Feb. 4, 2011

Related U.S. Application Data
(60) Provisional application No. 61/301,289, filed on Feb. 4, 2010.

(51) Int. Cl. G06Q 50/00; G06Q 30/00

(52) U.S. Cl. 705/27.1; 705/306

(57) ABSTRACT

A system and method for collective-based property valuation with a mobile client provides a user interface to a device that allows parties viewing a property to enter estimates of the property's value. Fields for a number of property attributes allow viewers to select scaled values indicative of supply and demand in a subject market. The values are used to create new cost-per-square foot and cost-basis valuations of the subject property. The accuracy of the home valuation improves with each additional valuation, resulting in valuations that truly reflect supply and demand in the subject market. Separate values for house, lot, estimated sales price and current market value are calculated and displayed. A past sales price engine estimates a current sales price based on a past sales price and the average appreciation for a neighborhood. A user interface feature allows different users to enter rating data in succession.

### CROSS REFERENCE TO RELATED APPLICATIONS

This application claims benefit of U.S. provisional patent application Ser. No. 61/301,289, filed Feb. 4, 2010, which application is incorporated herein in its entirety by this reference thereto.

### BACKGROUND

1. Field of the Invention

In general, the invention relates to property valuation. More particularly, the invention relates to a system and method for a web-based, online “User Directed Valuation Model” (UDVM).

2. Background Information

In the United States, there exist several different techniques or methods for valuation of real property. The income approach, also known as the income capitalization approach, values a property by capitalizing an income stream into an indication of value. Because it uses income data to arrive at an indication of value, the income approach is best-suited for valuing income-producing properties. It is only of marginal relevance in valuing residential real estate. The cost approach is based on the assumption that the value of a property may be estimated by summing the land value and the depreciated value of any improvements. Value of the improvements is generally referred to as replacement or reproduction cost minus depreciation. While the cost approach is considered to be reliable when applied to new structures, in practice the method has fallen into disuse because most residential neighborhoods have matured sufficiently that it is difficult to obtain recent comparable lot sales by which to value the land that a structure occupies. Thus, the cost approach has been largely superseded by the sales comparison approach, which is based primarily on data concerning recent sales of properties similar to the subject property being valued, called comparables. Because comparable sales are rarely identical to the subject property, the comparable values are usually adjusted based on, for example, sale date, location, amenities, square footage, lot size and so on. By analyzing adjusted sales prices of a group of comparable sales, an appraiser may arrive at cost per square foot estimate of a property's value.

Automated Valuation Models (AVMs) have recently become common. The first users of AVMs were financial institutions such as lenders and investment banking firms, who used them to analyze properties and assess the risk involved in various mortgage-backed securities. AVMs are now widely available over the Internet, and nearly anyone having Internet access can use an ordinary browser to obtain and view a valuation report in a matter of seconds. Typically, AVMs are automated embodiments of the sales comparison approach to property valuation, calculating a property's value at a particular point in time by analyzing values of comparables. Using the selling price of comparables, the software typically calculates an average value per square foot, arriving at a valuation of the subject property based on the house's square footage and the average value per square foot.

### SUMMARY

A system and method for a web based, online User Directed Valuation Model (UDVM) that provides users an interface on a common online software model to rate an item for sale- and receive back quantitative valuations for the subject property reflective of their inputs, as well as an algorithmic valuation of the subject property reflective of other user inputs. An embodiment of this USDVM invention relates to HomeToggle and real estate valuation as described below. The user selected values are processed within an algorithm to create new valuations for the subject property. Separate values for: house, lot, estimated sales price and current market value are calculated and displayed. A web-based online user interface allows different users to enter rating data simultaneously or in succession.

### BRIEF DESCRIPTION OF THE DRAWINGS

FIG. 1 provides a diagram of a machine in the exemplary form of a computer system within which a set of instructions, for causing the machine to perform any one of the methodologies discussed herein below, may be executed;

FIG. 2 provides a diagram of a client-server architecture for system for upon which a model for collective-based property valuation may be implemented;

FIG. 3 provides a screenshot of a landing page from a user interface to an application for collective-based property valuation;

FIG. 4 provides a screenshot of a landing page from the user interface of FIG. 3;

FIG. 5 provides a screenshot of a main Toggle page from the user interface of FIG. 3;

FIG. 6 provides a screen shot of a Toggle Search page from the user interface of FIG. 3;

FIG. 7 provides a screenshot of the sliders from the page of FIG. 5;

FIG. 8 provides a screen shot of a complete valuation report for a particular property;

FIG. 9 provides a screen shot of a CAMO (Competitive Agent Market Opinion) page for multiple users to successively generate valuations of a single property;

FIG. 10 provides a screen shot of a form for requesting a CAMO;

FIG. 11 provides a screenshot of a form for requesting that a property be Toggled;

FIG. 12 provides a screen shot of a form for displaying a particular viewer's Toggling history;

FIG. 13 provides a screen shot of a page for selecting Toggle settings and accessing tutorials;

FIG. 14 provides a screen shot of a form for generating a current value from the last recorded sale of a property;

FIG. 15 depicts a distribution of lot values;

FIG. 16 depicts a distribution of home sales;

FIG. 17 depicts a distribution of selling price per square foot ($/SQFT);

FIG. 18 provides a top-level diagram of a method for collective-based property valuation;

FIG. 19 provides a diagram of a method for calculating Fair Value in a Balanced Market (FVBM);

FIG. 20 provides a diagram of a method for calculating $/SQFT FVBM values;

FIG. 21 provides a diagram of an alternate method for calculating $/SQFT FVBM values;

FIG. 22 provides a diagram of a method for calculating lot values;

FIG. 23 provides a diagram of a method for calculated Estimated Selling Price (ESP); and

FIG. 24 provides a diagram of method for sorting experts to know which agents know which market segments best.

### DETAILED DESCRIPTION

The invention relates to a system and method for a web-based, online “User Directed Valuation Model” (UDVM): users interface on a common online software model to rate an item for sale- and receive back quantitative valuations for the subject property reflective of their inputs, as well as an algorithmic valuation of the subject property reflective of other user inputs. The efficiency of any market for thinly traded, unique, or difficult to value property increases with each additional user interaction.

One embodiment of this User Directed Valuation Model (UDVM) is Home Toggle which includes fields for a number of property attributes that allow viewers to select scaled values indicative of their concepts of supply and demand for specific real property in a subject market. The user selected values are processed within an algorithm to create new valuations for the subject property. Separate values for: house, lot, estimated sales price and current market value are calculated and displayed. An web-based online user interface allows different users to enter rating data simultaneously or in succession.

Another embodiment is of this UDVM Home Toggle: where values previously calculated by some other Automated Valuation Model (AVM—of which there are many) are presented on the Home Toggle interface for “qualified users” who then adjust the AVM values to make them more accurate and reflective of the supply and demand within the subject market.

A centralized, web-based, online Interface for:
Users interested in specific property to interact on a common software interface to calculate user specific valuations, and contribute to collective valuations.

An algorithmic process for:
Collecting, then dismantling then repackaging past sales data of similar property and displaying that data on a user interface either as percentages, qualitative names, or as actual values;
sorting users into various classes and segmenting their inputs and valuations by class
computing valuations from many user inputs for a subject property to create “Authenticated Valuations”;
creating a more efficient marketplace for property that is not frequently traded, unique, and/or difficult to value—resulting in a more efficient global economy.

On Online portal for:
Users to comment on or research comments about property
An online marketplace for specific property and/or conduit to send or receive bids or offers to or from other online marketplaces for specific property.
A centralized place for users knowledgeable about specific property types or property in various locations to contribute to the back end valuation model either by posting past sale data used in the model or by suggesting changes to the model to create an evolving learning system.
Users to hone their specific knowledge about property and transform that knowledge into more accurate property valuations
Users to contribute feedback to help evolve the algorithmic valuation process for each application of the ADVM
Users to calculate current home prices relative to the last recorded sale given general appreciation of home prices in any location as current in use within the “Value by Last Sale” (VBLS) Model.

This system and method is an web-based, online “User Directed Valuation Model” (UDVM) is collective property valuation tool, mobile accessible, and provides a user interface to a device that allows parties viewing or knowledgeable about specific property to rate characteristics of the property which the algorithmic models uses to compute valuations. Fields for a number of property attributes allow viewers to rate property on a scale as a function of supply and demand in a subject market. The data compiled from these ratings are used to create new valuations of the subject property. Separate values for house, ‘RESOC’ lot values, estimated sales price and current market value are calculated and displayed. An web-based online user interface allows different users to enter rating data simultaneously or in succession. A past sales price engine (VBLS model) estimates a current sales price based on a past sales price and the average appreciation for a neighborhood.

As described above, the most commonly used model for valuing real property, in particular residential property, is the sales comparison approach, which produces a cost-per-square foot value based on the square footage of the house. However, the simplest part of valuing a property is the valuation of the structure and improvements. Across large sample sizes in most markets and real property categories, there is surprisingly little variation in the structural value per square foot. The primary differentiator in the valuation of real property is the location in which the property is located. The selling cost per square foot of the house is a very poor and imperfect measurement of the value of the underlying lot, location and land. Thus, cost per square foot is a poor indicator of the most important elements of a property—its location, the attributes of the lot the house is situated on and the rights attaching to the lot. The Home Toggle interface creates accurate lot location values.

Most AVMs are automations of the sales comparison model. Thus, because AVMs use the sales comparison valuation approach, they inherently suffer the weaknesses of the sales comparison approach—which over values large homes on poor lots, and undervalues poor homes on great lots, generally overvalues larger homes, and generally undervalues a smaller homes. While the AVMs available today offer varying degrees of reliability, they all also suffer a major disadvantage in that a human appraiser has not seen the property being valued. Because no physical inspection of the property has taken place, AVMs do not reflect the condition of the property, an important variable in a property valuation.

In addition, because no physical inspection is possible, less tangible characteristics of the property, such as an unusually desirable, or, for that matter, undesirable lot, or a spectacular view and such, are not reflected in the automatically generated valuation report.

An additional disadvantage to AVMs is that the transaction data used by many AVMs is less than current, so that a valuation based on transaction data may not provide an up-to-date valuation.

The presently described system and methods introduce and establish a new residential real estate valuation standard based on an algorithmic valuation model powered by home sales data for periods of years in each location. In an embodiment, the valuation model is powered by at least seven years of sales data for each location. Subsequently, valuations are confirmed by the real estate community in each area, ultimately resulting in valuations that much more accurately estimate the market value of residential properties than other models currently in use. Community features of the application provide an online meeting place where realtors, buyers and sellers come to value homes and to discuss valuation and homes.

### Glossary:

Fair Value in a Balanced Market (FVBM): Fair value in a balanced Market describes a property valuation that reflects what a willing seller will accept and what a willing buyer will pay for a property in market conditions where supply meets demand perfectly. Because such conditions seldom occur in real markets, an embodiment of the “Fair Value in Balanced Market” is normalized to reflect actual market conditions;

Estimated Selling Price (ESP): Estimated Selling Price represents the FVBM normalized to reflect actual market conditions;

Residential Occupied Lot Value (RESOC): Represents the value of the land upon which an actual building structure is situated and the bundle of rights that transfer with the land;

Qualified User: A Qualified User is a user who knows both the characteristics of the housing supply in a narrowly-defined area and demand in the same area. In an embodiment, a Qualified User is generally a licensed real-estate professional such as a broker or an agent. Additionally, Qualified Users may be appraisers or lenders or well-informed lay people.

Each of various embodiments of the method and system herein described incorporate at least some of the following principles:
Qualitative rating of homes by a diverse group all interfacing on a common software platform to determine quantitative real estate valuations;
The algorithmic operation of a networked site by which HOME TOGGLE determines:
   back end data;
   a front end interface; and
   calculation of lot values (RESOC); and
   A past sales price engine.

The foregoing list is merely an overview and is not intended to be an exhaustive listing of the principles.

### Overview of the Home Toggle Platform

An embodiment of HOME TOGGLE may be described as a collaborative, collective real estate valuation platform. In an embodiment, the platform may constitute a form of wiki. The person of ordinary skill will appreciate that wikis are web sites that are well-suited for collaborative work such as the home valuation process herein described. User input both populates and authenticates the valuation data. An embodiment of HOME TOGGLE incorporates a user interface (UI) that can be run on any type of client device, for example: a mobile client, a handheld or laptop computer or a desktop computer. The HOME TOOGLE software, running as an application on either a client or an application server, accepts user input and runs the user input through a location-based algorithm to compute valuations of real properties, particularly residential properties. When a sufficient number of qualified users have “Toggled” or rated a property, the software is enabled to produce “authenticated” results, meaning that the computed valuation, being calculated from the input of a number of Qualified Users, is a more reliable indicator of a property's value than if the valuation were derived solely from input by unqualified users.

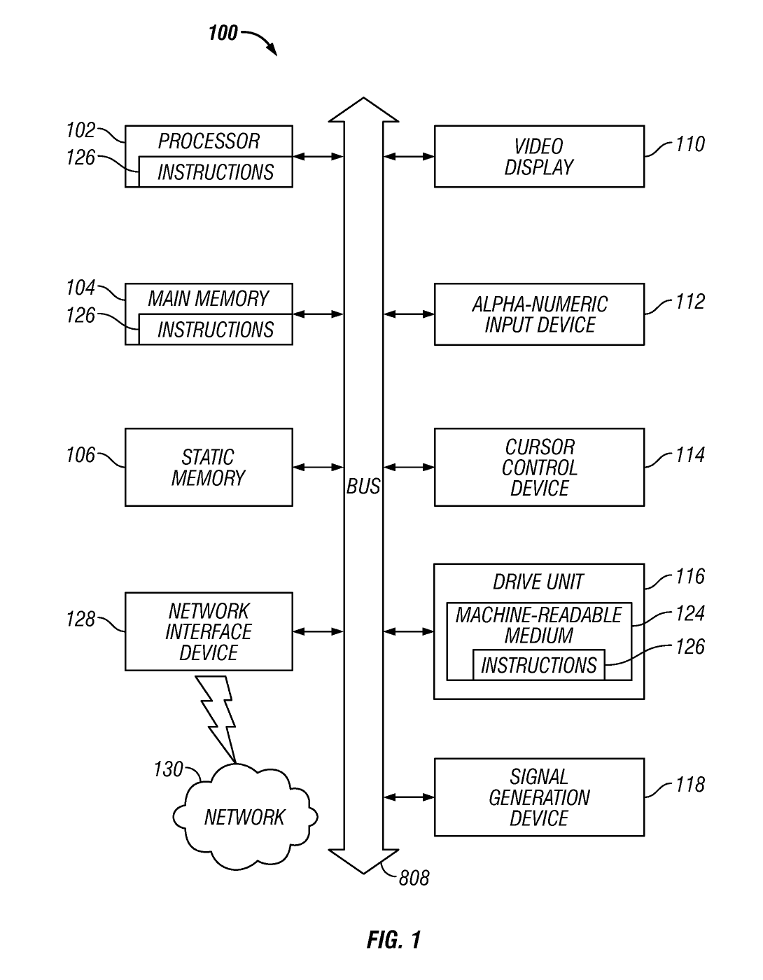

Referring now to FIG. 1, shown is a diagrammatic representation of a machine in the exemplary form of a computer system 100 within which a set of instructions for causing the machine to perform any one of the methodologies discussed herein below may be executed. In alternative embodiments, the machine may comprise a network router, a network switch, a network bridge, personal digital assistant (PDA), a cellular telephone, a web appliance or any machine capable of executing a sequence of instructions that specify actions to be taken by that machine.

The computer system 100 includes a processor 102, a main memory 104 and a static memory 106, which communicate with each other via a bus 108. The computer system 100 may further include a display unit 110, for example, a liquid crystal display (LCD) or a cathode ray tube (CRT). The computer system 100 also includes an alphanumeric input device 112, for example, a keyboard; a cursor control device 114, for example, a mouse; a disk drive unit 116, a signal generation device 118, for example, a speaker, and a network interface device 128.

The disk drive unit 116 includes a machine-readable medium 124 on which is stored a set of executable instructions, i.e. software, 126 embodying any one, or all, of the methodologies described herein below. The software 126 is also shown to reside, completely or at least partially, within the main memory 104 and/or within the processor 102. The software 126 may further be transmitted or received over a network 130 by means of a network interface device 128.

In contrast to the system 100 discussed above, a different embodiment of the invention uses logic circuitry instead of computer-executed instructions to implement processing offers. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complimentary metal oxide semiconductor), TTL (transistor-transistor logic), VLSI (very large scale integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments of this invention may be used as or to support software programs executed upon some form of processing core (such as the Central Processing Unit of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information. Additionally, a “machine-readable medium” may be understood to mean a “non-transitory” machine-readable medium.

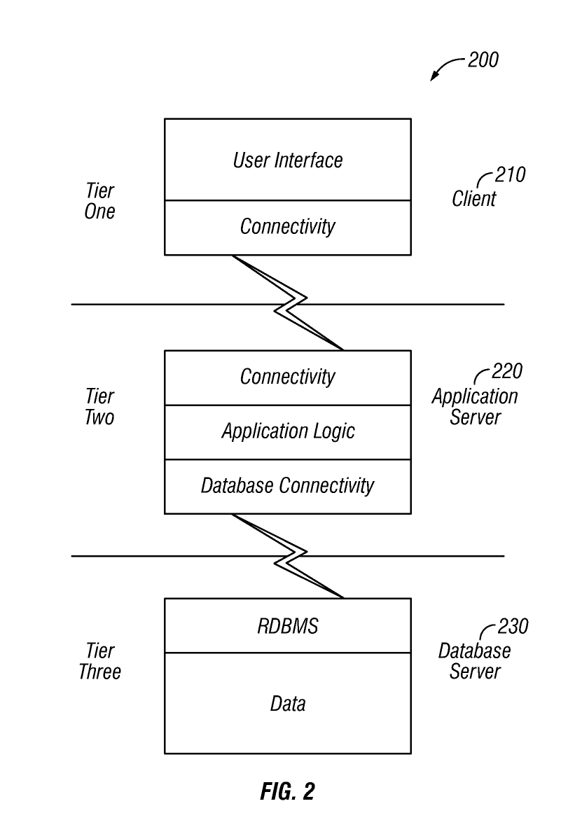

Referring now to FIG. 2, shown is a block diagram of a client-server architecture 200 over which at least one embodiment is implemented. In overview, the client-server architecture separates the various processes of an application into separate tiers, or layers. In an embodiment, each tier is housed separately from the other tiers on a separate device. In other embodiments, the tiers may be distributed across computing devices in other ways. In additional embodiments, the tiers may all be housed on a single computing device. As shown in FIG. 2, a client-server architecture may include a client 210, an Application server 212, and a database server. 214. As shown in FIG. 2, the client 210 may house the presentation layer, or user interface. In an embodiment, the user interface may be made up of a number of pages that one can access with a browser-type application. By interacting with the presentation layer or user interface, the user requests data from the database by entering input via various user interface elements. Additionally, the user, via the user interface is able to input data upon which the application layer may act, and which may also be saved to the database 214. Also, by means of the user interface, the user views data returned by the system in response to the user request.

The application server may house the application logic, such as business rules and functional modules that actually process data. For example, in the presently described system, the user enters his/her own estimates of a property's value according to a series of attributes. The system returns a valuation that incorporates the user's input. It is business logic housed within the application layer 212 which retrieves saved home sales data from the database, performs the calculations required to produce a home valuation from the user's estimates, saves the new value to the database and reports the new value to the user via the user interface. Thus, the application layer provides most of the functionality specific to the present system and method. The application layer, however, does not store persistent data. In an embodiment, the presentation layer and the application server may both reside on a single device.

Finally, the database server 214 may house a database management system and a database for processing and storing persistent data. It is to be appreciated that the present system and method are data-driven, relying, for example, on years of sales data for various communities and neighborhoods. Additionally, the described system and method are constantly incorporating new data in the form of user input and are constantly generating new data in the form of current property valuations. It is the database layer 214 which stores all of this data and manages it by means of a suitable DBMS (database management system).

In addition to the foregoing, the various tiers or layers also incorporate connectivity elements for communicating with the adjacent tiers or layers.

In an embodiment, the client 210 may be a handheld wireless device such as a Smartphone, upon which at least the presentation layer is implemented. In the present embodiment, the wireless device may communicate wirelessly with the Application layer 212. In an embodiment, both the presentation and the application layers reside on wireless device, wherein the wireless device communicates via a wireless connection to network containing the database layer 214. While a wireless handheld client potentially offers those viewing properties great convenience and flexibility, allowing them to immediately enter their value estimates of the property and to receive a valuation even while they are inspecting the property, in additional embodiments, a client may be a free-standing data collection terminal, either wireless or wired. Additionally, in other embodiments, the client 210 may be a handheld computer, a laptop computer, or even a desktop computer upon which at least the presentation layer has been implemented.

In an embodiment, the database that orchestrates behind the scenes stores the sales data which power the Toggle Valuation Algorithm. Additionally, the database role includes:
Storing of past valuations, including an algorithmic output that averages valuations both among realtors but also among realtors and the general public
Enabling real estate agents to create browse-able profiles with past sales, client ratings, and so on;
Powering the reporting functionality;
Enabling buyers to create profiles, lists of desired characteristics in a house, and to save and rate favorite homes; and
Providing an annual appreciation database of home prices in each area so Togglers can estimate how much a home would have sold for in any given year in the past, or they can use it to help them with their present Toggle valuation.

### User Interface

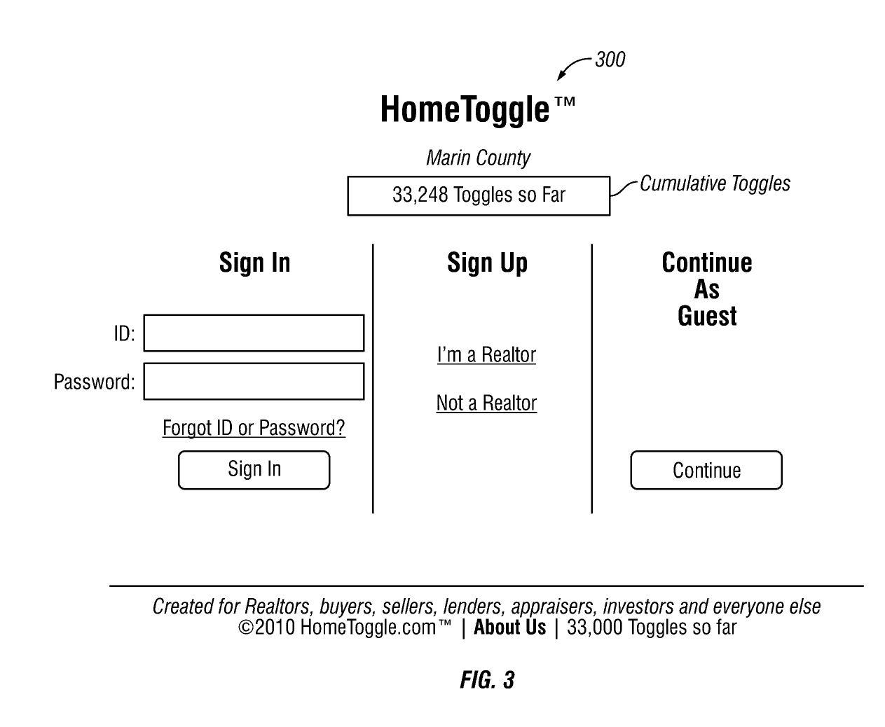

As shown in FIG. 3, the User Interface (UI) includes a landing page 300. In an embodiment, the landing page may include one or more from at least the following elements:
Agent log in;
Privacy Pledge; and
Non-agent login.

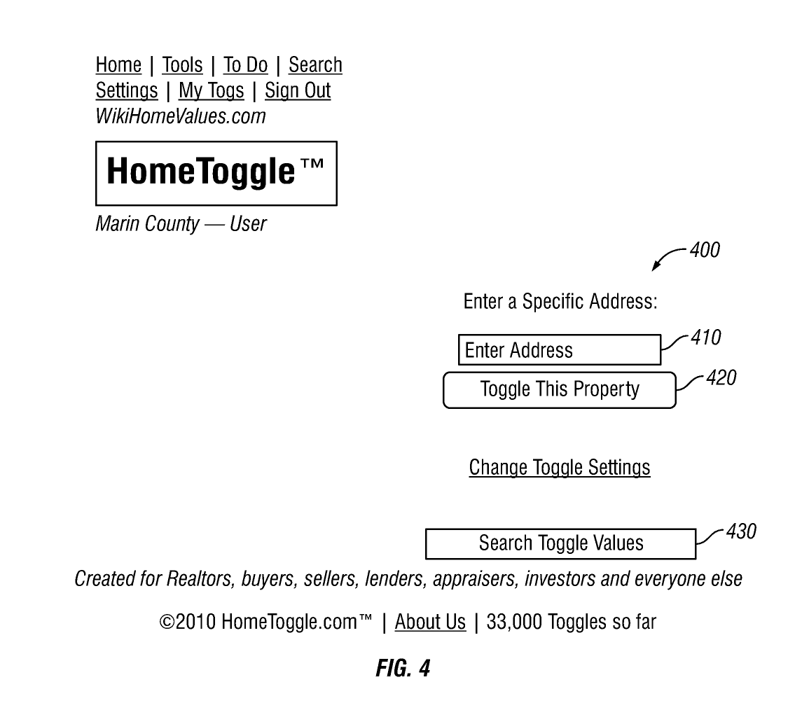

As shown in FIG. 4, in an embodiment, the UI may include a home page 400, wherein the user has already logged in from the landing page 300 and now resides on the home page 400. In an embodiment, the home page 400 may include one of more of at least the following menu options:
Tools;
Settings; and
My Togs.

If the user hasn't logged in and has instead selected an option to “Continue as a Guest” from the landing page 300, the home page display is identical to that shown for registered users except that “Tools, Setting, My Togs” link to a message that says “Please log in to use these tools” when clicked.

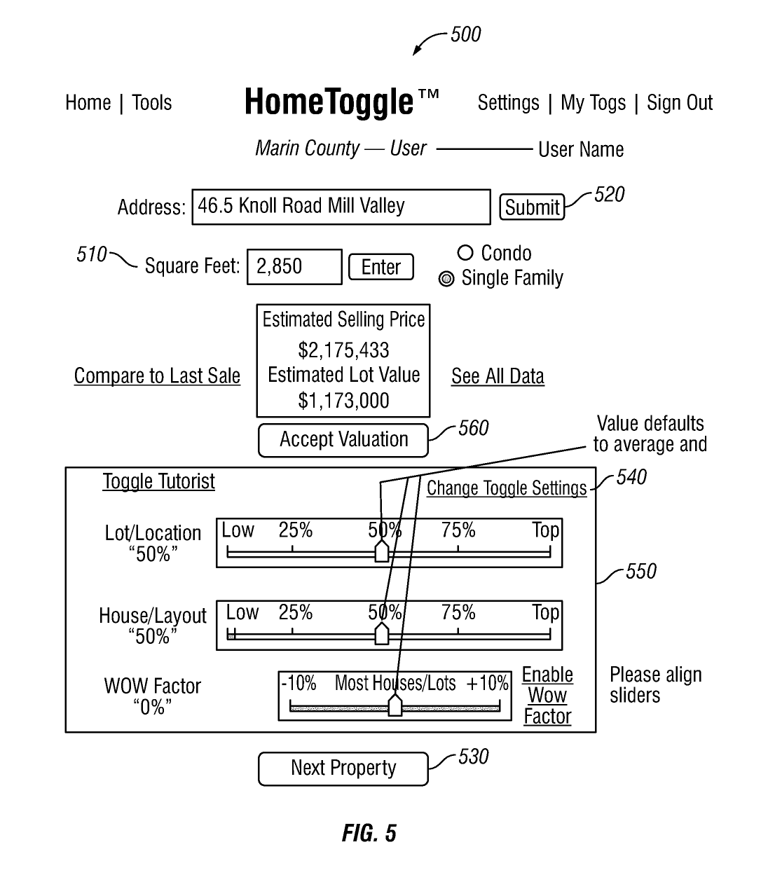

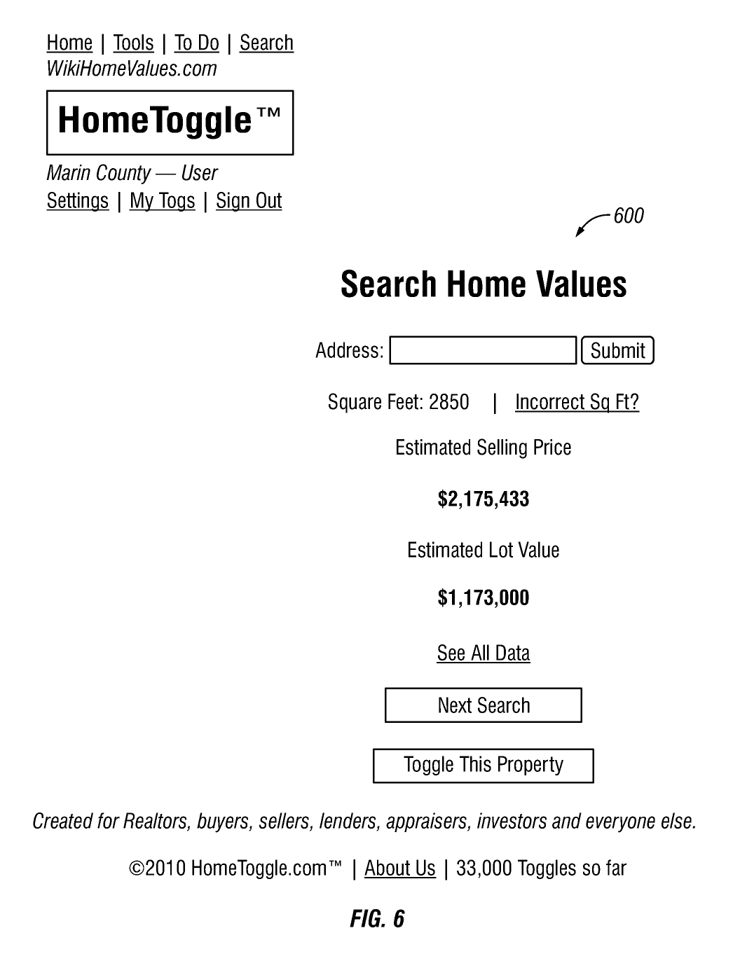

From the home page 400, the user my enter an address 410 and can click either “Toggle this home” 420 or “See Home Toggle Values” 430. If the user selects “See Home Toggle Values”, he/she is navigated to a page 600 that that allows him/her to search home values. If the user selects “Toggle this Home”, he/she in navigated to a main Toggle page 500, as shown in FIG. 5. Once the user gets to the main Toggle page 500 he/she has already passed the landing page and entered an address on the Home Page and clicked “Toggle This Property” 420. In an embodiment, the square footage 510 of the target home may automatically load from a database such as the tax roll database. Alternatively, if the square footage is unavailable, the user may be prompted to enter the square footage. In an embodiment, for user-entered square-footage values, a popup may inform the user that the square footage is not confirmed by the system records. In an embodiment, the user is given the option of overriding the system and continuing for comparison purposes. If a user enters a new address in the Address Input Box 520, the software refreshes the page and resets the sliders. Alternatively, if the users selects “next property” 530, the software exhibits the same behavior. The main Toggle page 500 includes an option “change Toggle settings” 540, which when selected allows the user, to for example, select “high-end options”, which automatically populates the sliders with high-end property values. Otherwise, the sliders 550 and values automatically load as the average value in the database.

### Slider Operation

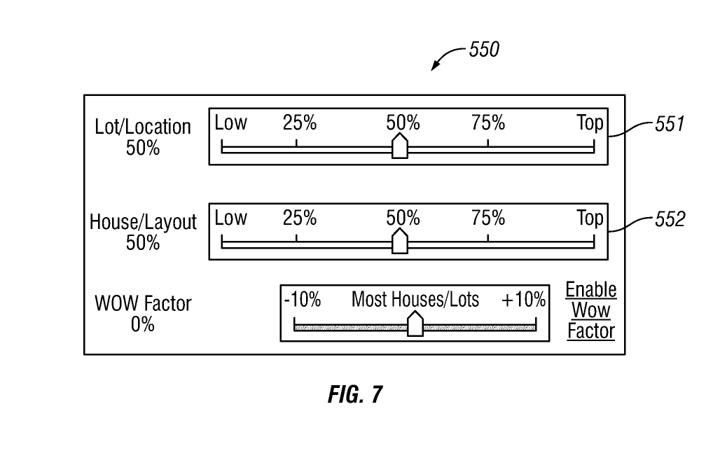

Referring now to FIGS. 5 and 7, as the user slides values left or right, the values “Lot/location” 551 & “House/Layout” 552 change in real time. As described elsewhere herein, the sliders are mapped to data sets produced from deconstructed home sales data, organized according to percentile. If a user drags the House/Layout value all the way to the left, a “Tear Down” legend may appear under, for example “House/Layout”. In the case of guest users, in an embodiment, the Lot/Location slider does not populate, instead displaying a “Please Log in” prompt.

Shown in the main Toggle page 500, Sliders & values default to average when the screen loads, for example:
Enter Address;
Square footage auto loads;
Every home starts out as average;
Lot value; and
Structure value;
   So there is an automatically loaded average valuation; and
   The user slides the scale to adjust average valuation in real time.

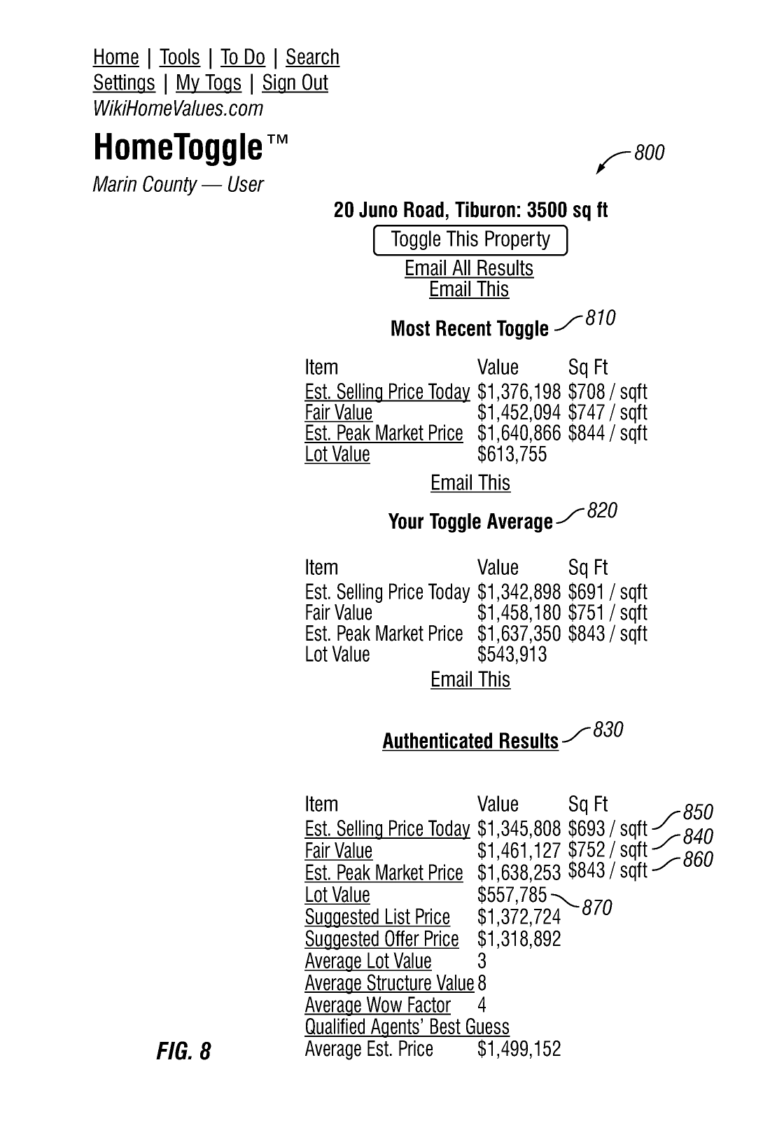

When the user selects “Accept Valuation” 560, in an embodiment, a link appears under “See All Data” that says “Email This Toggle”, shown in FIG. 8. Thus, the software gives the user the option of viewing the valuation at once and the additional option of emailing the Toggle (valuation), to, for example, themselves or another party, such as a business associate or a spouse. In an embodiment, the email option allows the user to email subsets of values, such as: “Most recent Toggle”, “Your Toggle average”, “Authenticated Results” or all three. When the user selects the email option one or more links to one or more Toggle result pages are emailed. In an embodiment, each property may have its own Toggle Result page. After receiving five qualified Toggles the property is automatically given an “Authenticated Result” designation.

### High-End Options

As shown in FIGS. 5 and 7, a user may enable high end options in the sliders on the main Toggle page and on the CAMO page.

### Wow Factors

As shown in FIGS. 5 and 7, a user may enable WOW factors in the sliders on the main Toggle page and on the CAMO page.

### Slider Bar Points

In an embodiment, there are 100 different points on the slider each corresponding roughly to 1% of housing stock and lot values

### Value Outputs

Referring now to FIG. 8, after the user Toggles a property, as in FIG. 5, a complete valuation report 800 for the property is displayed.
Most Recent Toggle: The user's most recent Toggle 810;
Your Toggle Average: When the same user Toggles the same house more than once 820;
Authenticated Results: In an embodiment, an authenticated result is based on valuations of at least five qualified agents. As described herein below, Agents become qualified first by self-selecting a number of towns in a vicinity during the initial account profile set-up in which they are highly informed as to the value of the housing stock and market conditions 830;
Fair Value: What the house should sell for in a balanced market (FVBM) 840;
Estimated Selling Price Today 850;
Peak Market Price: What the house would have sold for at the top of the market, as defined by a predetermined market peak 860; and
Lot Value: The value of the lot occupied by the structure 870.

### Competitive Agent Market Opinion (CAMO)

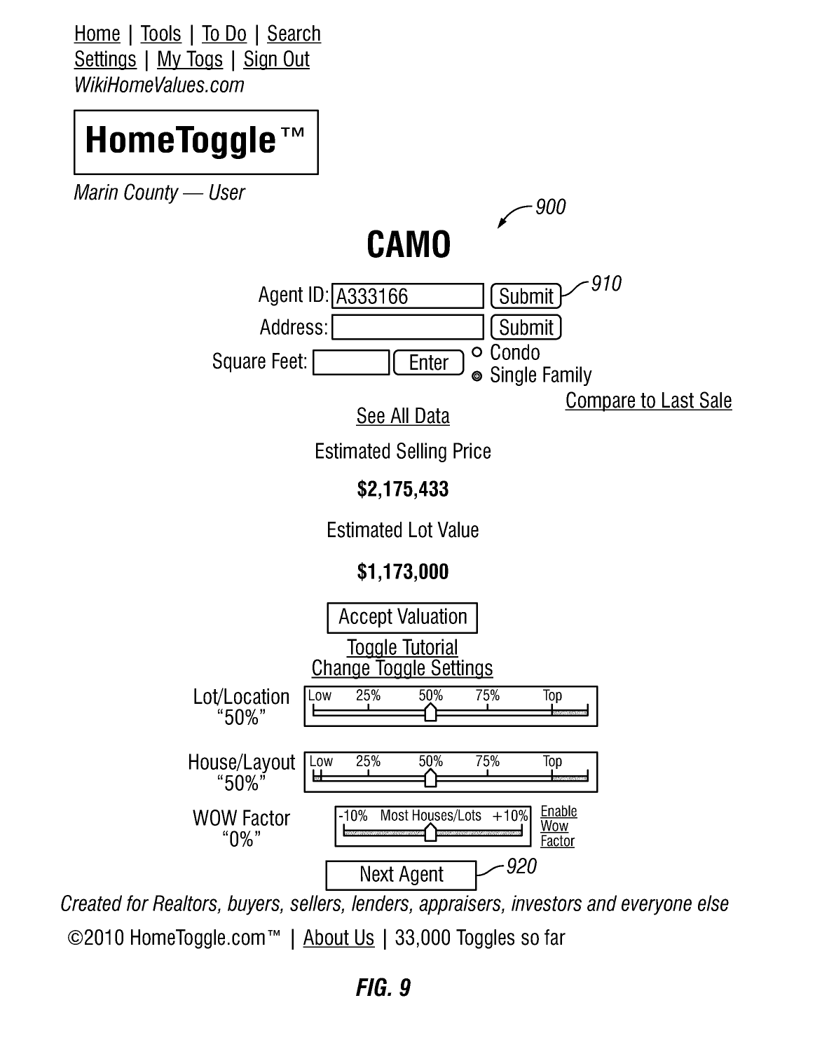

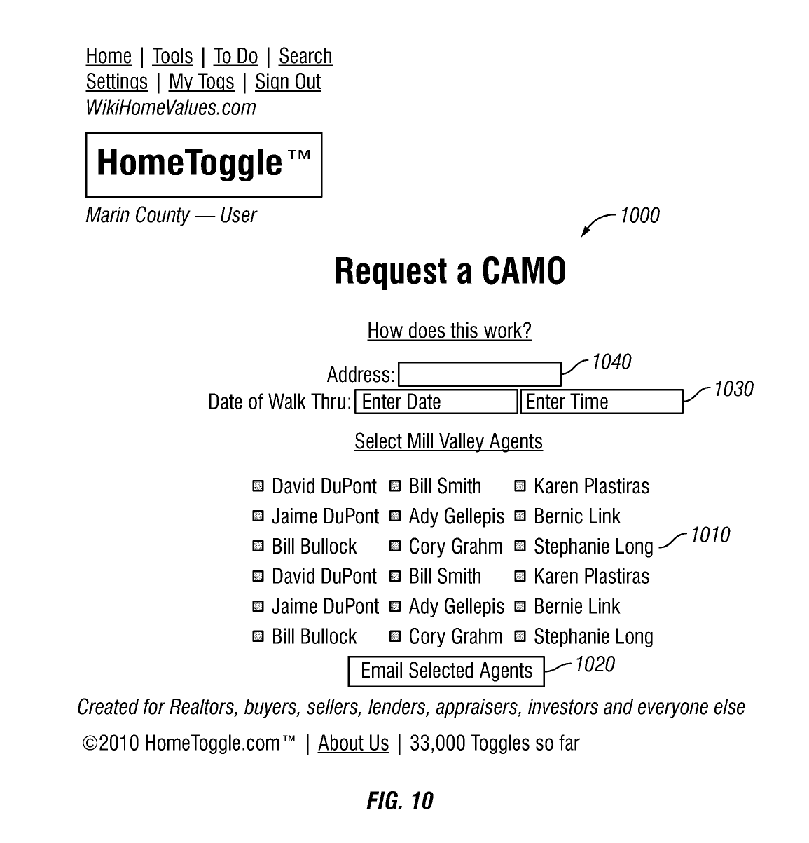

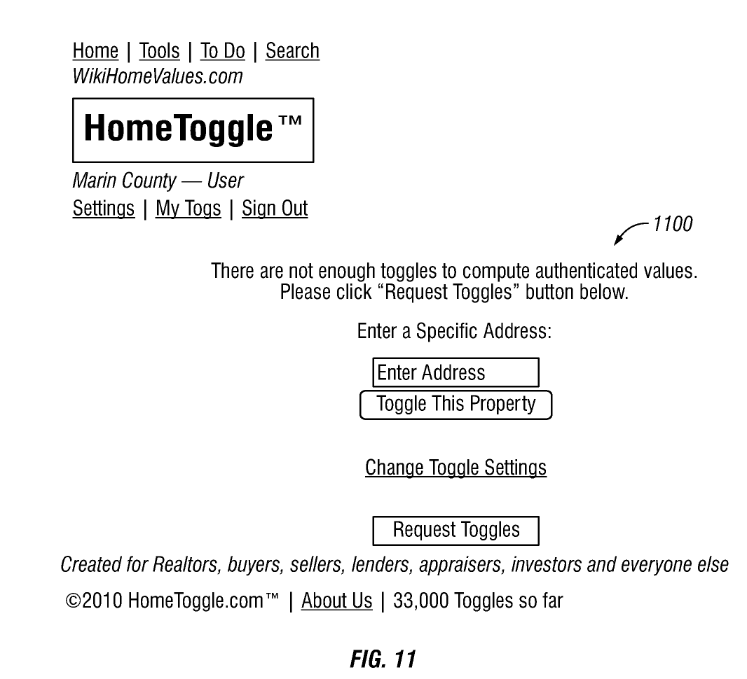

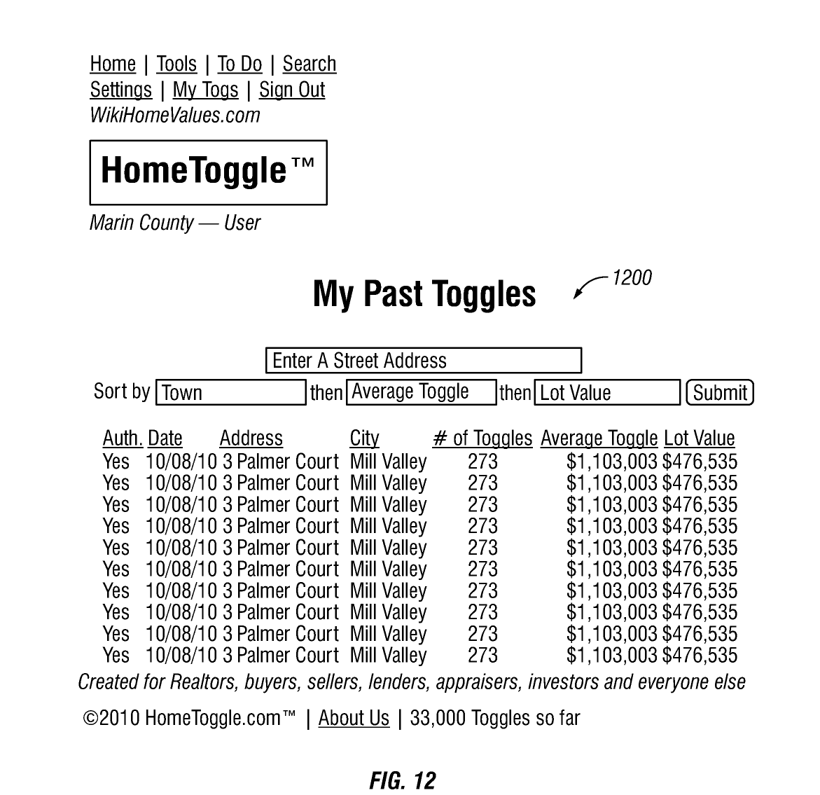

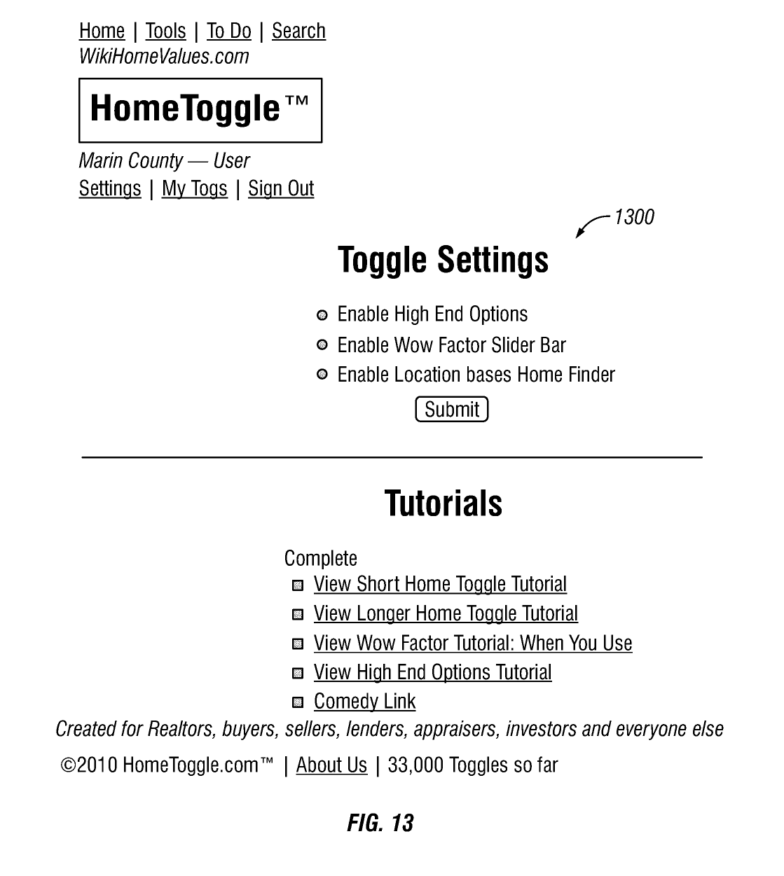

As shown in FIG. 9, the UI includes a CAMO page 900. As explained elsewhere herein, the system and methods described are directed to a collective-based approach to real property valuation, wherein the valuation process is driven and refined by the user input: as successive users value a property, successive valuations reflect prevailing market conditions more and more accurately. In particular, the collective-based process is driven by the input of licensed real estate professionals, in view of their highly-informed opinions regarding property values and market conditions within one or more selected locales.

The CAMO page 900 is used in settings where it may be desirable for a number of different users each to Toggle the same property using a single client device. In an embodiment, the CAMO page closely resembles the main Toggle page 500 except for the Agent ID field 910. In practice, each party, usually a licensed real estate professional, enters his/her login credentials. In an embodiment, each party is only required to enter a user name without a password. As each agent enters his/her credentials, his/her name may display in the ‘Agent’ field of the page 900. Each agent then enters his/her estimates of the property's value. Selection of the “Next Agent” UI element 920 saves the agent's valuation, clears the agent number and name fields, while leaving the address and square footage fields populated. Otherwise, all values are reset to their defaults. While anyone may use the CAMO feature, valuation entered by way of the CAMO page 900 may only be saved if the agent ID field is populated.

A “Request CAMO” page 1000 allows a user to invite agents to a CAMO. In an embodiment, the Request CAMO page 1000 provides a number of fields 1010 for entering the names of people to be invited to the CAMO. It is to be appreciated that the CAMO is a feature/service targeted primarily, but not exclusively, to the community of real estate professionals. Upon activation of the correct UI element 1020, the software automatically emails an invitation to all of the listed invitees, giving the time 1030 and the address 1040 of the listed property. Invitees are able to accept/decline the invitation by email.

### Search Home Values

The “Search Home Values” page 600 allows users to view Home Toggle House Values, without Toggling homes themselves. The can access the page 600 either by accessing a “Search” link at the top of the main Toggle page or by selecting a “Search Toggle Values” Button. If there are no “Authenticated Values” in the database, when the person hits ‘submit’ on the “Search Home Values” page 600, the user is navigated to a “Request Toggles” page 1100, where he/she can request that a particular property be Toggled. Only if there are authenticated values for the property, will they be displayed.

### Searching My Past Toggles

A “Searching My Past Toggles” page 1200 allow users to search properties that they have Toggle in the past. In an embodiment, users can search Toggles by entering a query, such as street name; or they may use a “to-do” link at the top of the page. “Requested Toggles” populates the “Toggle-Do” List. “My Toggle-Do's” is populated by “Requested Toggles” and all homes that have less than five qualified Toggles. After a property has received seven qualified Toggles, the requested home is removed from the Requested Toggle List and all users who requested the Home Toggle are sent an email informing them that the property is now authenticated.

### Google Maps Integration

As described elsewhere herein, in an embodiment, the software constitutes either a mobile app or wiki desktop home valuation software. The mobile APP embodiment is configured to run on an API such as GOOGLE. If a mobile device queries the database, the Home page loads with a link that enables or disables ‘Location Based Address Verification’ 1300 in the GOOGLE API. If the user can't find an address in the auto populated list, he/she can start typing in an address and the site automatically queries the closest address first and then a County tax roll database of addresses thereafter.

### Auto Loading Address Input Box

As in GOOGLE Maps, when someone starts typing/entering an address, the software presents a list of selectable matches. The more characters typed in, the fewer options until there remains only one match.

### Tools

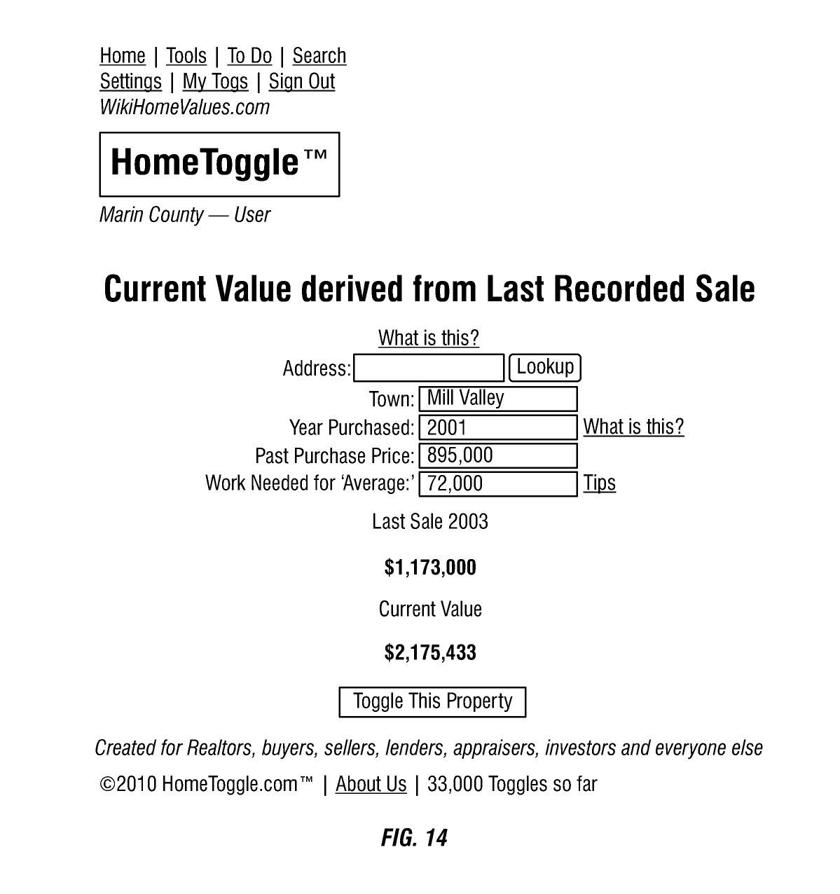

Toggle Settings
Value by last Sale (FIG. 14)
Request Toggle
CAMO

### User Experience

The HOME TOGGLE User Experience

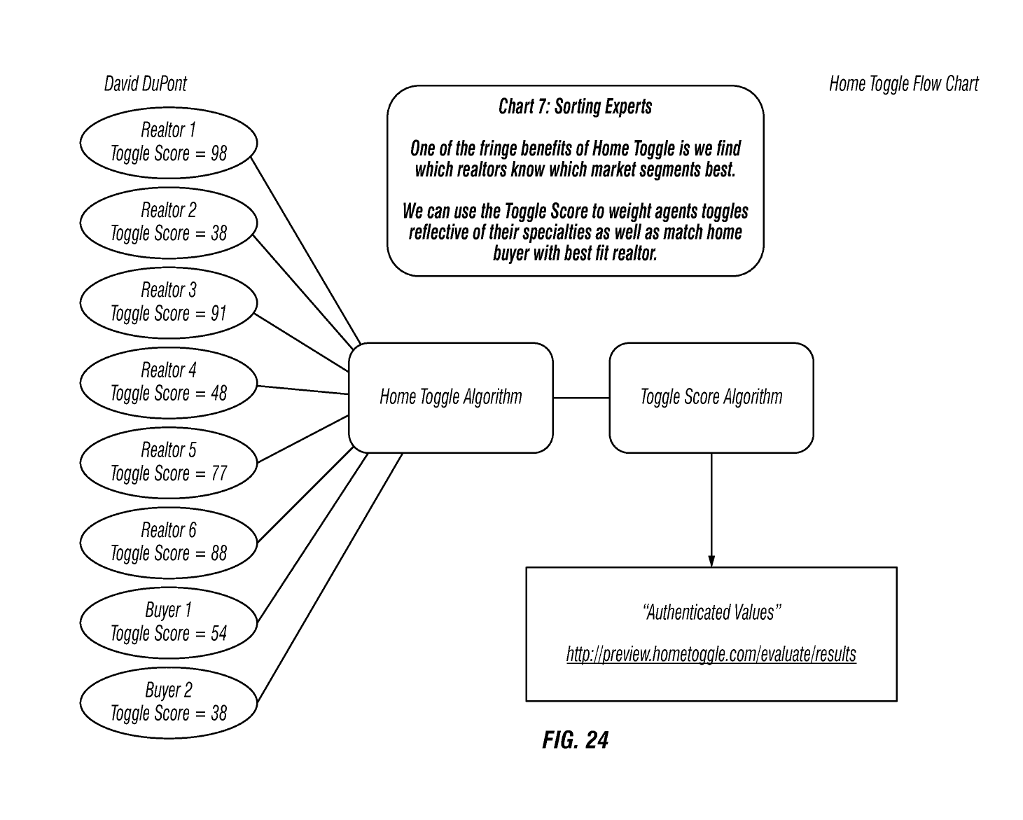

The user experience of HOME TOGGLE may include a number of basic functions:
Home Valuation using HOME TOGGLE Software:
   Login;
   Enter Address and Confirm;
   Select Radio Button: Single Family or Condo;
   Enter or confirm Square footage;
   Select Lot/location Value on Slider;
   Select House/layout value on Slider;
   Select “WOW” factor on slider; and
   Click Toggle.
Signing in and controlling preferences & settings:
   Agents;
   Setting primary and secondary areas of specialization;
   Updating profile information;
   Real Estate ID number, email, phone, info etc;
   Past sales of homes;
   Checking Toggle score;
   A score may be given to each agent who values/Toggles a home. The score will be generated an algorithm related to how active the agent is in the real estate community as witnessed by how many homes they “Toggle” and how accurate they are in predicting the sales price;
   Home buyers and sellers will eventually be able to browse agents' Toggle scores together with anonymous agent profiles to select agents to find the agents that specialize in the area and price range where they are shopping. As shown in FIG. 24, agents may be sorted by Toggling history to simplify the task of finding an Agent having expertise in a particular neighborhood or community.
Non Agents use of site:
   Searching HOME TOGGLE Values on interesting properties
   Selecting agents via their profiles and Toggle scores
   Saving home profiles and rating homes, adding pictures and notes, creating a qualitative database of home attributes
   Vendors:
   checking insurability limits
   Smart Mortgage algorithm (described in detail herein below)
Community Feedback—see below
   Comments on the user experience with the software
   Improving the site
Tweets & BLOG. The site's purpose is to:
   introduce a forum for user populated qualitative rating of homes;
   the calculation of ‘Residential Occupied’ (RESOC) Lot Values;
   The most accurate current and forecasted Home Values found anywhere;
   residential real estate valuation standard;
   The site uses an algorithmic valuation model and is powered by a distribution of home sales typically last 7-9 years, in each location;
   Valuations are confirmed by the real estate community in each area;
   The site is online meeting place where realtors, buyers and sellers come to value homes, to discuss homes and valuations;
   The database that orchestrates behind the scenes does the following
      Power the Toggle Valuation Algorithm;
      Record past valuations and create graph-able data sets over time;
      Enable Realtors to create profiles with past sales, with client ratings, and testimonials;
      Power all our reporting functionality;
      Enable buyers to create profiles, lists of desired characteristics in a house, and save and rate favorite homes;
      There is also a database of home prices in each area so Togglers can estimate how much a home would have sold for in any given year in the past, or use it to help them with their present Toggle valuation.

### Steps Involved in the Home Toggle Algorithmic Process

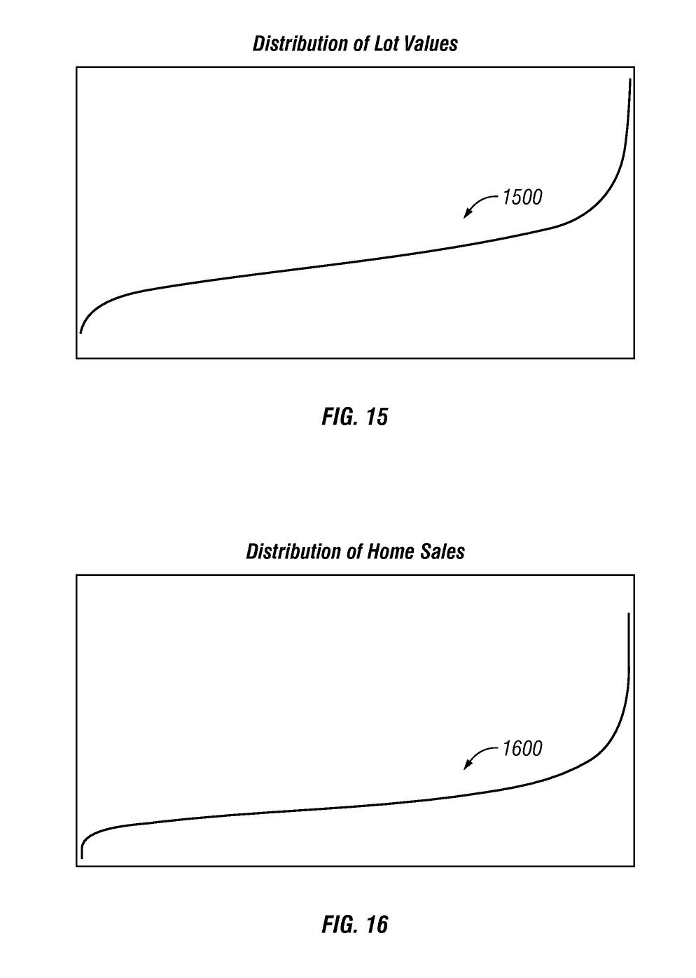

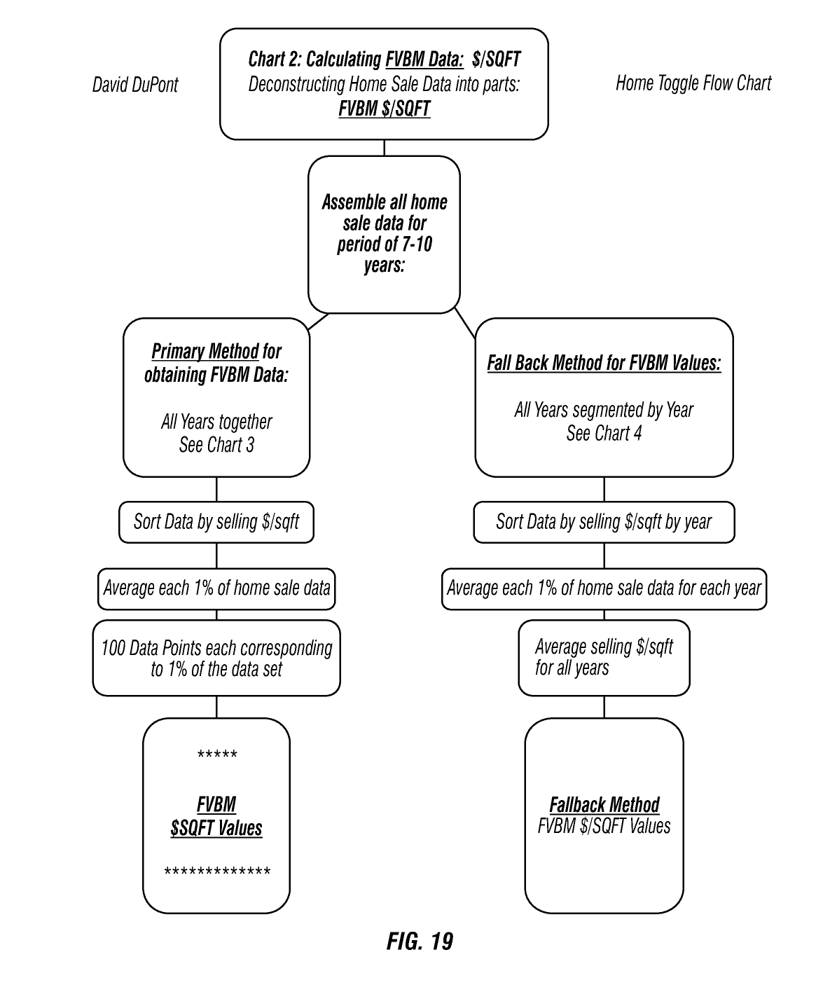

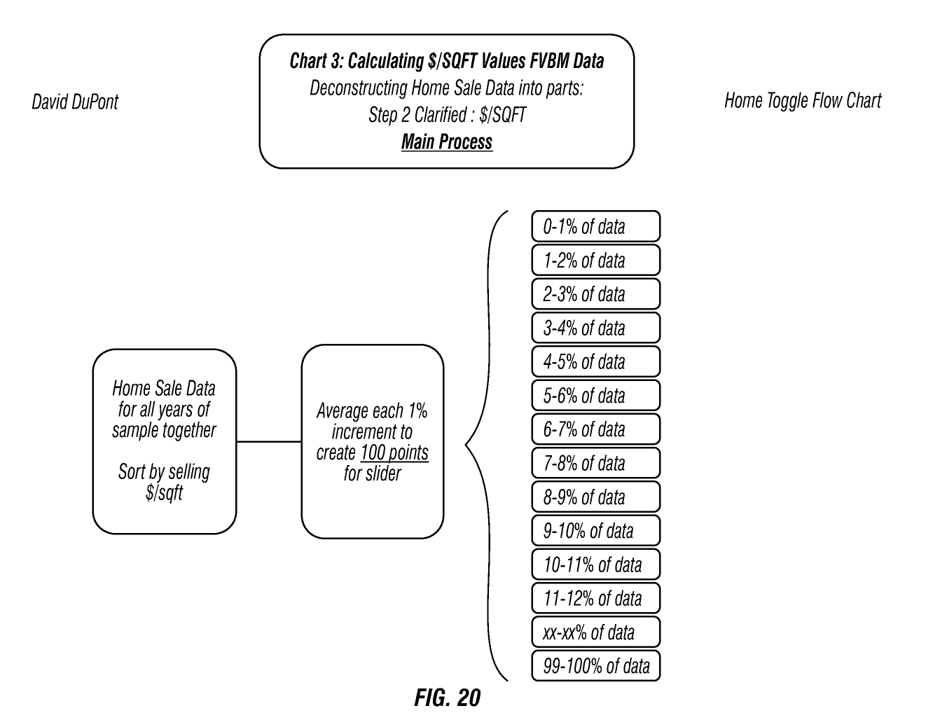

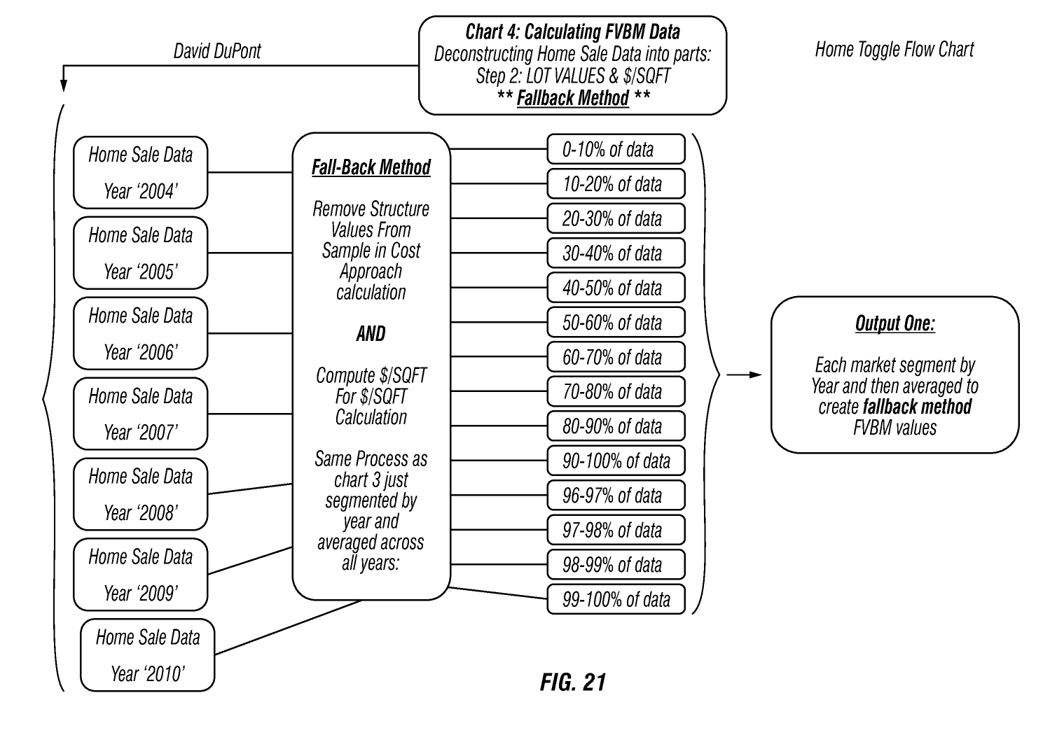

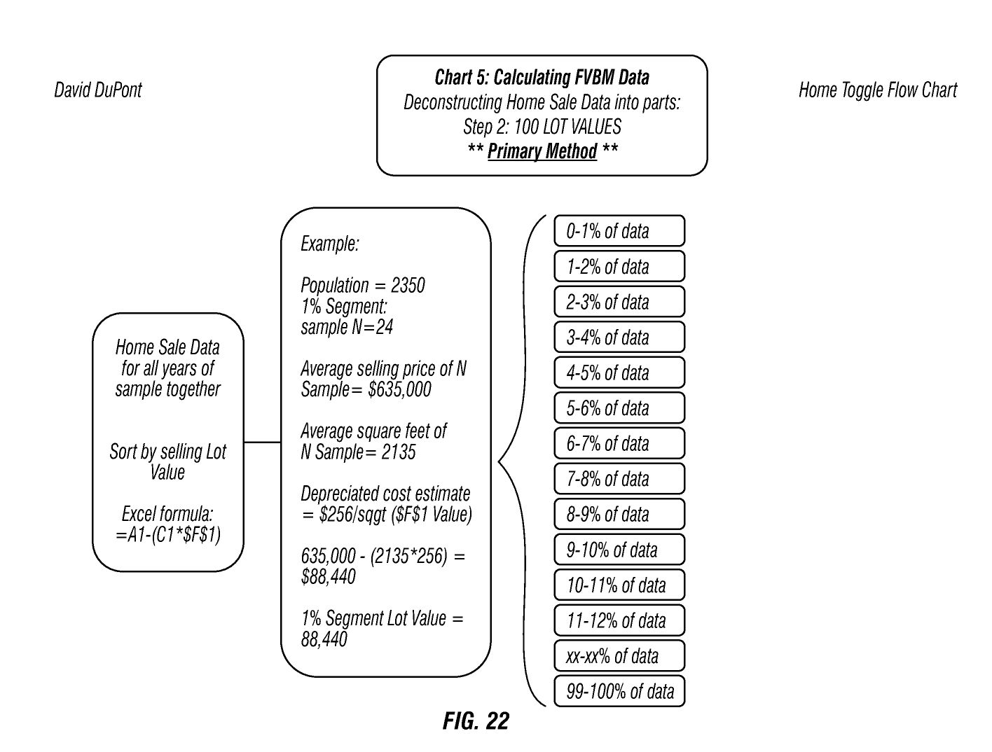

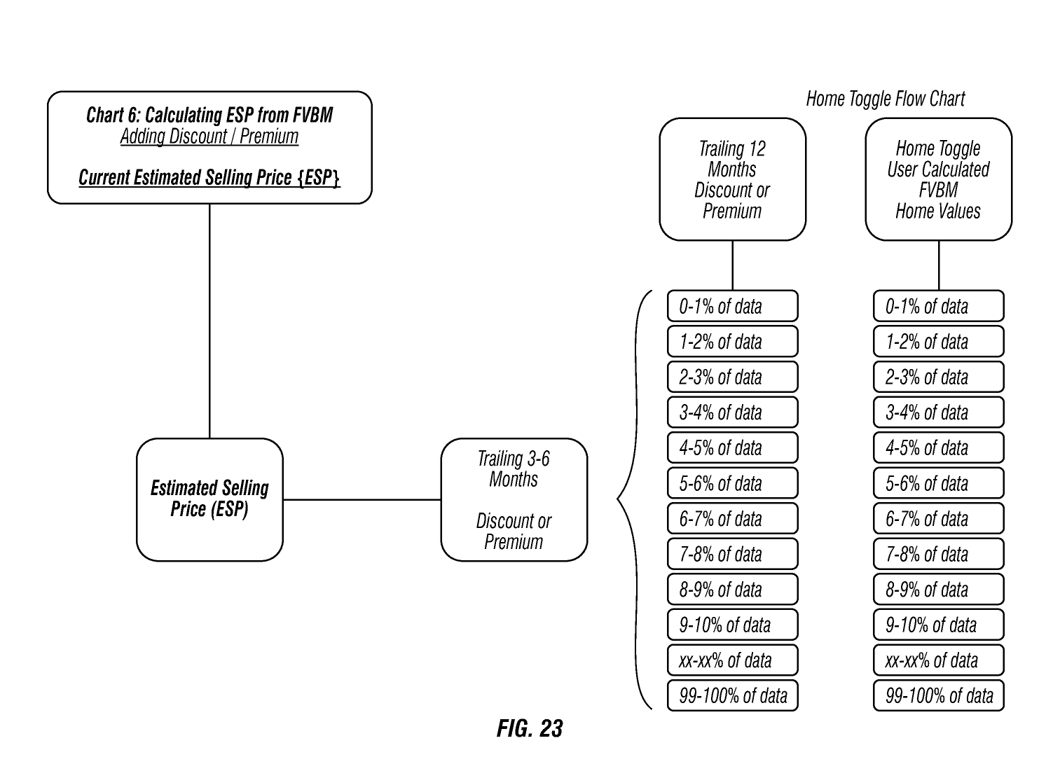

Calculating HOME TOGGLE Data: “FVBM Values”;
   Sort homes sale data and deconstruct to create data used in:
The HOME TOGGLE rating and valuation process, as in FIG. 5;
   “reconstructing” home valuations from the rating entered by the user.
Calculating HOME TOGGLE Data: “Deconstructing Home Sale Data “See Charts 2-5 (FIGS. 19-22).
   These values power the “FVBM” or ‘Fair Value in a Balanced Market’ data set values;
   The modified” Cost Approach”: Performing the calculation:
      Remove the average structure cost from a population of sales to achieve lot value for each market segment;
         Input all the home selling price data for any given community during a specific period of time in a spread sheet in three (A,B,C) columns:
                     |Column A: sales price|Column B: lot value|Column C: square feet|
         Lot value calculated by subtracting a community-specific depreciated cost estimate to rebuild from an average selling price for the population of values, as shown in FIG. 22.
      Sort by Lot Value (FIG. 22).
      Segment the population by each 1%
         The HOME TOGGLE Modified “Cost Approach” sorting function counts the number of data points in the populations, segments the population by each 1%, averages each 1% and performs the below calculation to create 100 different values for use in the HOME TOGGLE Slider
      Example:
         Bottom 1% of a data set (2350): population=235
         Average selling price of population=$635,000
         Average square feet of populations=2135
         Depreciated cost estimate=$256/sqgt
         635,000−(2135*256)=$88,440
         Lot Value for the bottom 1% of population=$88,440
            Chart (FIG. 15) The HOME TOGGLE distribution of lot values 1500.
THE MODIFIED “SALES COMPARISON APPROACH”: PERFORMING THE CALCULATION:
   Input all the home selling price data for any given community during a specific period of time in a spread sheet in three (A,B,C) columns:
               |Column A: sales price|Column B: Selling $/SQFT|Column C: square feet|;
   Sort them by selling $/SQFT.

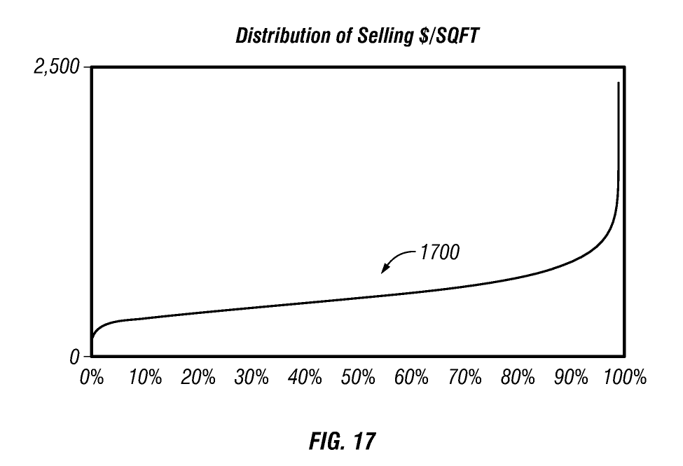

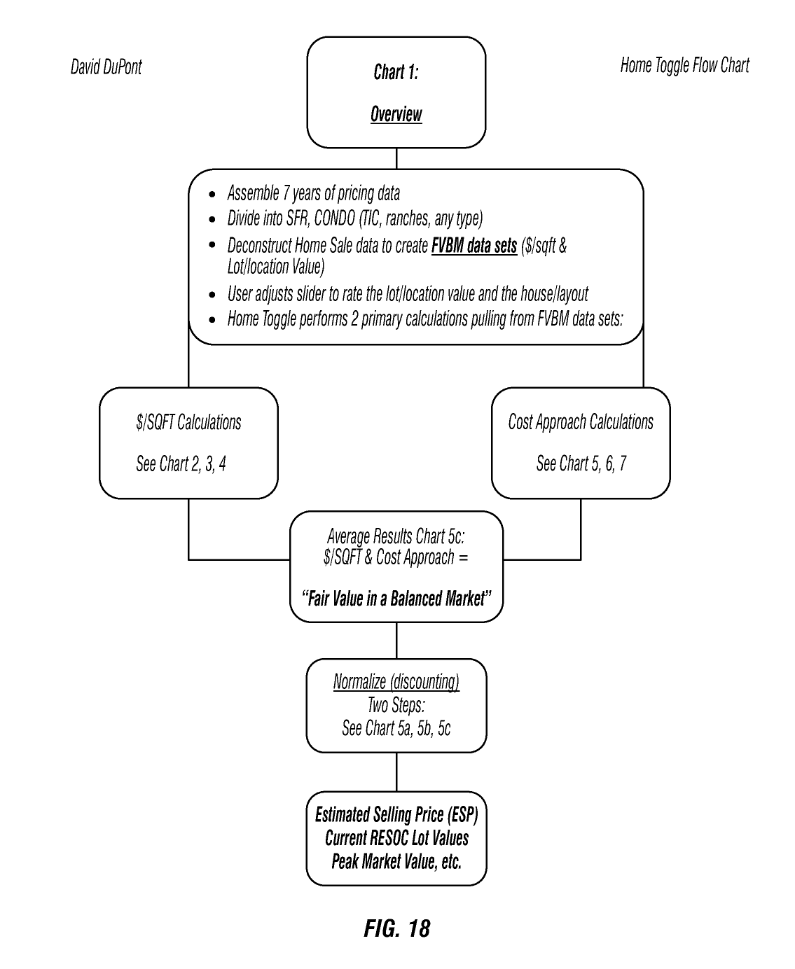

FIG. 17 shows a distribution curve 1700 for selling $/SQFT.
Segment the population by each 1%
   The HOME TOGGLE modified “Sales Comparison” sorting function sorts by selling $/SQFT, counts the number of data points in the population, segments the population by each 1%, and averages each 1%, creating 100 different values for use in the HOME TOGGLE Slider;
Example:
   Bottom 1% of a data set (2350): population=235;
   Average selling $/SQFT of bottom 1%=$235/sqft
Selling $/SQFT for the bottom 1% of population=$235 per sq. ft.
In some cases we may use the same process described above where the home sale data is segmented by year and the output of is then averaged across years, see chart 3)
   The HOME TOGGLE Rating and Valuation process: “Reconstructing Values” (See Chart 1, FIG. 18)
This algorithm utilizes simple qualitative communal input criteria to produce an accurate, quantitative valuation output;
The algorithm performs several calculations for specific segments of the residential real estate market:
   Single Family homes;
   Condominiums, TICs, and so on;
The Algorithm is powered by two primary calculations that smooth the inherent valuation errors found in using just one of the calculations. These inherent errors include over- or under-valuation based upon the square footage of the home and its condition, the location, the lot and other variables.
Calculations:
   Modified ‘Cost Approach’;
   Modified ‘Sales Comparison Approach’ by $/SQFT;
Primary data sets used in the calculation:
   Lot Values;
   Selling $/SQFT;
   Depreciated costs to rebuild;
      where the average value=the value used in the lot value deconstruction process;
   Current Discount/Premium:
      This takes FVBM and creates the “estimate selling price” (ESP);
   The user rates two attributes of a subject Property relative to:
      Supply (Housing Stock in the community in which the home is located);
      Demand (what buyers are looking for);
   using the HOME TOGGLE Sliders:
      Rate: Lot/Location Value
      Rate: House/Layout Value: using slider bars, as shown in FIGS. 5 and 7;
   When the user has moved the sliders to the appropriate position, HOME TOGGLE calculates the Home Value by reconstructing the home value using our two modified HOME TOGGLE calculations:
      The “Cost Approach” calculation; and
      The “Modified Sales Comparison” calculation; and
      Then Averages the output of both.
The 3 Calculations:
   Calc #1: “Cost Approach”=sqft*Input structure cost+lot Value;
      Input Structure cost=from Depreciated costs to rebuild data set;
   Calc #2: “Sales Comparison”=sqft*$/sqft Value
$/SQFT Value=is an average of the following two:
   An average of the two fields selected→
      one value from lot value slider; and
      one value from in structure value slider
   Pulled from $/SQFT table
   An average of the entire range;
The output—“Fair Value in a balanced market” (FVBM) is an average of appraisals 1 & 2, or the outputs of Calc #1 and Calc #2;
Calc #3: Estimated Selling Price (ESP): Add Discount or premium to FVBM to get “Estimated Selling price” (ESP)=FVBM*Current Discount/premium data point
   To calculate the current Discount/Premium: Two Steps
      Step 1: Perform the “Deconstruction ‘Sales Comparison’ Calculation” for the trailing 12 months (100 values), and then divide by the corresponding FVBM value
      Example:
         FVBM 1% value−$235/sqft
         Discount 1% value=$221
         Discount for 1%=221/235=95%
      Step 2: Trailing 3 or 6 month average appreciation/depreciation
         1 value for all 100% points
   Other Calculations
      Peak market Value=Fair value*Peak premium Value
         1 Value for all 100 points
   Current Lot Value
      Lot Value*Current Discount/premium (12 month data, 100 points)

### Authentication of Home Toggle Values

Realtors specify 1-5 communities of specialization;
   In Each of these communities they are considered “Qualified Agents”;
   Realtors can qualify for more than 5 communities by the accuracy of their Toggles in that community;
Once 5 Qualified Agents Toggle a home, “Authenticated Values” are produced.
   Creating Housing Data from a Sample
There is a consistent distribution of Home Sales in Each location, as shown in FIG. 16:
The slope of the line changes by location and it is possible to automatically calculate all home sales based on:
   a random sample of selling prices;
   the minimum;
   the maximum; and
The mean.

### Problems Addressed by Home Toggle

The primary way that brokers & agents, buyers & sellers alike value real estate is by evaluating Recent Market Comparables—that is homes that have sold recently that are comparable to a subject property.
   The Problem with this approach is that Market Comparables closely track the business cycle.
      At the top of the business cycle, valuation by evaluating recent market comparables directs buyers to overpay and banks to over-lend. This is exactly what just happened in the recent housing and banking crisis:
      At the bottom of the business cycle, relative home value by comparables is muddied by distressed sales which typically transact at lower price points than non-distressed sales. This is happening right now.
The Valuation performed by this algorithm is formulated to assess “Fair Value in a Balanced Market” (FVBM), given 7-10 years of pricing data;
“Fair value in a balanced Market” is an economic concept where supply meets demand perfectly.
Because economic concepts like this occur very seldom in real markets, the “Fair Value in balanced market” is normalized to reflect current market conditions.
   Normalization is accomplished by discounting each segment of the market by the trailing 12 months sales activity. These homes sales are run through the same algorithmic functions as described above to generate a discount for each market segment.
   Discounting
      In extreme markets where prices are falling or rising very quickly there is another discount or premium applied to the “Fair Value in Balanced Market” to predict selling actual selling prices given the current conditions, and this is a single value formulated by the trailing 3-6 months (depending on number of sales).
Confirmation of Valuation
Short term Confirmation
   The median and/or mean HOME TOGGLE Values for each location are either confirmed or unconfirmed by mean and/or median household incomes in that area;
   Confirmation is defined by the affordability of average and/or median housing prices falling within an acceptable range of after tax income.

### The Community & Collective Valuation

This algorithm utilizes simple qualitative communal input criteria to produce an accurate, quantitative valuation output that creates a structured appraisal by collective;
The real estate community application of this algorithmic appraisal model is the most dynamic and important aspect of this valuation model;
   There are 3 basic groups of Community Users
      Licensed real estate professionals;
      Non-Real Estate Professionals
         Buyers, Sellers, and Tire Kickers
         Lenders & Insurers
         Other users
      Pro Togglers
         Pro Togglers are mainly licensed real estate professionals, but can be anyone who knows supply and demand well enough in the community to accurately Toggle homes.

### Home Toggle Smart Mortgage

This is a tool for lenders and estimates how far below “Fair Value in a Balanced Market” a foreclosed home or short sale trades in every market segment in all communities covered by HOME TOGGLE;
Similar to computing the discount for each market segment, all of the foreclosures and or short/sale homes are input into their respective spreadsheets and run through the same algorithm functions to show lenders and investors estimated sales proceed given a foreclosure or short-sale situation for a subject property.

### Normalization

Normalization is accomplished by discounting each segment of the market by the trailing 6-12 months (depending on number of sales) sales activity. These home sales are run through the same algorithmic functions described above to generate a discount for each market segment.

### Discounting

In extreme markets where prices are falling or rising very quickly, another Discount or premium can be applied to the “Fair Value in Balanced Market” to predict selling actual selling prices given the current conditions.

### Confirmation of Valuation

### Short Term Confirmation

The median and/or average for each location is either confirmed or unconfirmed by mean and/or median household incomes in that area relative to the mean or median selling price. Confirmation is defined as the affordability of average and/or median housing prices falling within a band of 30%-37% of after tax income.

### Intermediate—Long Term Direction Score

Expected Job Growth, or level, or contraction;
Expected growth in incomes, level, or contraction;
Expected growth in taxes, level or decrease in taxation.

### Performing the Valuation

There is a nearly limitless range of possible qualitative determinations by prospective buyers of homes they are considering buying, from the highly improbable to the pragmatic. In general, however they all fall into 1 of 2 categories:
Response to the Lot/location—refer to Step 8 below;
Response to the structure/layout/finishes—step 9 below.

In another embodiment, instead of the slider bars (FIGS. 5 and 7), the UI includes interface elements such as pull-down menus with which the user specifies value ranges. In the case of the present embodiment, the steps followed by a user to perform a valuation may include one of more of the steps of:
1. Login;
2. Select Town;
3. Enter Address and Confirm;
4. Select Radio Button: Single Family or Condo;
5. Select Radio Button: within 95% of Housing Stock of ‘Mill Valley’ or Ultra High End top 5%;
6. Enter or confirm Square footage;
7. Select Pool value & Click Continue;
8. Enter Lot Value Range into 2 drop down boxes;
9. Enter Structure Condition & Finishes Range into 2 drop down boxes;
10. Click Toggle;
11. View output; and
12. Re-Toggle, if desired.

Once the user performs steps 8 and 9, the algorithm performs two valuations, as described herein above, and averages them:
Cost approach valuation
$/Sqft valuation.

### The Community & Collective Pricing

The valuation algorithm utilizes simple, qualitative communal input criteria to produce an accurate, quantitative valuation output that creates a structured appraisal by collective. Typically, community users fall within any of several groups:
Licensed Real estate professionals;
Non-real estate professionals:
   Buyers, Sellers, and Tire Kickers;
   Lenders & Insurers; and
   Other users.
Pro Togglers
   Each user is graded on the accuracy and frequency of their appraisals via the use of the Toggle Score Algorithm. Users who have entered a large number of Toggles which have predicted sales prices with better-than-average accuracy may be given the designation of “Pro Toggler”;
   After a user has distinguished himself as a Pro Toggler, his score will be presented as an average alongside other Pro Togglers as another indicator of relative value.

While the presently-described algorithmic appraisal model is available to all users, without regard to the user's status, the most important drivers of the appraisal model are those from the professional real estate community. The algorithm requires users to input a range for two criteria (lot value, structure value) relative to the housing stock of that community. Because the model requires the users to compare the subject property relative to all other homes that they have seen in that community, understanding the relative aspect of the model is the key to using the model accurately. It will be appreciated that the inputs to the model of real estate professionals, because of their intimate familiarity with the housing stock in their communities and with prevailing market conditions, are considerably more informed than those of ordinary users. Additionally, embodiments of the model are configured primarily to the needs of the community or licensed real estate professionals.

As described above, because the model is data-driven and collective-based, as it continues to receive input, the valuations it produces become much more accurate, continually becoming truer representations of the market value of the rated properties in view of actual market conditions in the community. All user “HOME TOGGLE”s or “appraisals” are saved in the database and run through another algorithm together with the Toggle score of the appraiser to output a particular valuation, herein designated a “Fair Value in a Balanced Market”.

Furthermore, because of the communal, online aspect of the model, both the user experience and output of the model will evolve going forward, continually reflecting changes within the economic and real estate environment.

### Home Valuation by Collective

This is defined as: the community's use of the HOME TOGGLE algorithm, filtered by the Toggle score algorithm to create an estimate of “Fair Value in a Balanced Market”.

### Fair Value in a Balanced Market (FVBM)

FVBM is a novel economic concept wherein Supply of residential housing in every market segment equals Demand perfectly. The application of this principle to real estate valuation assures that the national economy will never over-leverage the housing stock of communities and, correspondingly, of the nation again. In times of increasing prosperity, homes are likely to trade above FVBM but banks should lend only against FVBM value.
Example: If banks require a home buyer to deposit 30% of the purchase price in the form of a down payment and the purchase price is 10% above HOME TOGGLEs Estimate of Fair Value, the required down payment should therefore be 40%.
Example:
   333 Allen Street, San Francisco, FVBM=100,000
   Buyer is in contract to pay $110,000;
   Bank requires 30% down payment;
   Down payment=(FVBM*0.3)+(110,000-FVBM)=$40,000.

Conversely, in times of falling prosperity, homes are likely to trade at a discount to FVBM. During these times Banks will lend against the contract price. FVBM is also a key concept for both buyers and seller to grasp in falling markets as it will facilitate the understanding of relative value in the marketplace and create greater liquidity for home sellers.

### Smart Mortgage

A SMART MORTGAGE tool estimates how far below “Fair Value in a Balanced Market” (FVBM) a foreclosed home or short sale will trade in every market segment in all communities and any given time.

Similar to computing the discount for each market segment, all the foreclosures or short sales are input, as above, and run through the foregoing algorithm to show lenders and investors estimated sale proceeds given a foreclosure or short sale situation for a subject property.

### Past Sales Price Engine

In an embodiment, a past sales price engine estimates a current sales price based on a past sales price and the average appreciation for a community.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A computer-implemented method for collective property valuation comprising the steps of:
a computational device mapping one or more data sets derived from home sales data to a scale used by a user to enter scalar ratings of a subject property;
a computational device accepting said user ratings, said user ratings indicative of at least one attribute of said subject property related to supply and demand in the housing market of a community in which the property is located;
a computational device calculating a collective-based valuation of said subject property from said user ratings; and
a computational device outputting the collective-based valuation.

2. The method of claim 2, wherein said collective-based valuation is known as a Toggle and wherein said Toggle includes a plurality of values calculated at least from said user rating, said values including one or more of:
Fair Value in a Balanced Market (FVBM);
Estimated Selling Price (ESP);
Residential Occupied Lot Value (RESOC);
Peak Market Price;
Authenticated Results;
said user's most recent Toggle for the subject property; and
said user's Toggle Average for the subject property.

3. The method of claim 2, wherein said authenticated results comprise Toggles from a qualified user, wherein said qualified user comprises a user having documented knowledge of the housing stock in said community and of market conditions in said community.

4. The method of claim 1, wherein the step of a computational device accepting scalar user ratings of a subject property comprises:
responsive to said user entering said estimates by means of user interface elements for specifying said values, a computational device accepting said estimates.

5. The method of claim 4, wherein said user interface includes user interface elements for one or more of:
receiving a user-entered property address;
receiving a user-entered property type;
receiving a value indicating square footage of at least one structure on said property;
receiving a user-entered estimate of a value of said at least one structure;
receiving a user entered-estimate of a lot occupied by said structure;
receiving a user request to calculate a valuation for said property; and
displaying said calculated valuation.

6. The method of claim 1, wherein said step of a computational device calculating a collective-based valuation of said subject property from said user ratings comprises one or more of the steps of:
a computational device calculating a sales comparison-based valuation of said property;
a computational device calculating a cost-approach-based valuation of said property; and
a computational device calculating an average of said sales comparison-based valuation and said cost-approach-based valuation of said property, wherein said average comprises Fair Value in a Balanced Market (FVBM).

7. The method of claim 6, wherein said step of calculating a sales comparison-based valuation of said property comprises the step of:
a computational device calculating a product of square footage of said subject property and a value per square foot, wherein said product comprises said sales comparison-based valuation.

8. The method of claim 6, wherein said step of calculating a cost-approach based valuation of said property comprises the steps of:
a computational device calculating a structure cost for said property by calculating a product of square footage of said structure and a location-based value for depreciated cost to rebuild, wherein said product comprises said structure cost;
a computational device adding said structure cost to a lot value for said property wherein sum of said adding operation comprises said cost-approach based valuation.

9. The method of claim 8, further comprising the steps of:
a computational device calculating said lot value of said property.

10. The method of claim 9, wherein said step of calculating said lot value of said property comprises the steps of:
a computational device calculating a product of square footage of said structure and a value of depreciated cost to rebuild, said product comprising a depreciated value of said structure;
a computational device subtracting said depreciated value of said structure from a total selling price for said property, wherein a result of said subtraction comprises said lot value.

11. The method of claim 6, further comprising the step of:
a computational device normalizing said FVBM to represent current market conditions, wherein said normalized FVBM comprises Estimated Selling Price (ESP).

12. The method of claim 11, wherein said step of normalizing said FVBM comprises the step of:
a computational device discounting each market segment by sales activity for twelve trailing months.

13. The method of claim 11, wherein said step of normalizing said FVBM comprises either of the steps of:
a computational device discounting said FVBM by a single value calculated from sales data for 3-6 trailing months; and
a computational device adding a premium to said FVBM, said premium comprising a single value calculated form sales data for 3-6 trailing months.

14. The method of claim 1, further comprising the steps of:
a computational device storing prior home sales data for a period of at least seven years, said prior home sales data comprising: sales price, lot value, and square footage, each of said sales price, lot value and square footage stored in a separate column of a data structure;
a computational device calculating a sales price per square foot;
a computational device sorting said prior home sales data by said sales price per square foot.

15. The method of claim 14, further comprising the steps of:
a computational device calculating an average for each percentile of prior home sale data, resulting in 100 data points; and
mapping said scale to said 100 data points.

16. The method of claim 14, further comprising the step of:
preceding said step of sorting said prior home sales data by said sales price per square foot, a computational device segregating said prior home sale data by year.

17. The method of claim 1, wherein said data sets comprise at least
a data set of lot values for said community;
a data set of selling price per square foot of home sales for at least the prior seven years for said community; and
a date set of depreciated costs to rebuild for said community.

18. The method of claim 1, further comprising the steps of:
a computational device receiving ratings from a succession of invited, qualified users in a single session;
a computational device calculating a separate collective-based valuation of said subject property from said user ratings input by each invited, qualified user; and
a computational device separately outputting said separate collective-based valuations;
wherein said session comprises a Competitive Agent Market Overview (CAMO).

19. The method of claim 1, further comprising the steps of:
a computational device estimating a current sales price based on a past sales price and the average appreciation for a community.

20. An apparatus for collective-based property valuation comprising:
a processor configured for mapping one or more data sets derived from prior home sales to a scale used by a user to enter scalar ratings of a subject property;
a processor configured for accepting said user ratings, said user ratings indicative of at least one attribute of said subject property related to supply and demand in the housing market of a community in which the property is located;
a processor configured for calculating a collective-based valuation of said subject property from said user ratings; and
a processor configured for outputting the collective-based valuation.

21. A method of using an apparatus for collective-based property valuation comprising the steps of:
selecting a community;
entering a property address;
specifying a housing type;
specifying a market segment;
entering or confirming square footage of a structure on said property;
in the case of a property having a pool, specifying a pool value;
estimating a lot value;
estimating a value of structure value;
requesting calculation of said valuation; and
receiving said valuation.

22. A tangible computer-readable medium, said computer-readable medium having computer-readable code embodied thereon for performing the steps of a method for collective-based property valuation, the method comprising the steps of:
mapping one or more data sets derived from prior home sales to a scale used by a user to enter scalar ratings of a subject property;
accepting said user ratings, said user ratings indicative of at least one attribute of said subject property related to supply and demand in the housing market of a community in which the property is located;
calculating a collective-based valuation of said subject property from said user ratings; and
outputting the collective-based valuation.

23. A method of using a system for web-based user-directed valuation comprising the steps of:
a plurality of interacting users rating an item offered for sale by means of at least one computational device programmed with a common online software model; and
each of said plurality of users receiving back quantitative valuations for the for the item offered for sale reflective of their ratings; and
each of said plurality of users receiving back an algorithmic valuation of the he item offered for sale reflective of other user ratings; and
each of said plurality users increasing efficiency of a market for said item offered for sale with each additional interaction among said plurality of users.
efficiency of any market for thinly traded, unique, or difficult to value property increases with each additional user interaction.

24. A system for web-based user-directed valuation comprising:
a computational device programmed for a plurality of interacting users to rate an item offered for sale; and
a computational device programmed for each of said plurality of users to receive back quantitative valuations for the for the item offered for sale reflective of their ratings; and
a computational device programmed for each of said plurality of users to receive back an algorithmic valuation of the he item offered for sale reflective of other user ratings; and
a computational device programmed for increasing efficiency of a market for said item offered for sale with each additional interaction among said plurality of users.
